(19) United States
(12) Patent Application Publication
(10) Pub. No.: US 2009/0162658 A1
(43) Pub. Date: Jun. 25, 2009

(54) Process for the preparation of nanocrystalline hydrotalcite compounds

(75) Inventors: Hans-Jorg Wolk, Rosenheim (DE); Stephan Muller, Munchen (DE)

Correspondence Address: RATNERPRESTIA, P.O. BOX 980, VALLEY FORGE, PA, 19482, US

(73) Assignee: SUD CHEMIE AG, Munchen (DE)

(21) Appl. No.: 12/316,467

(22) Filed: Dec. 12, 2008

(30) Foreign Application Priority Data
Dec. 13, 2007 (DE) 10 2007 059990.2

(51) Int. Cl. B32B 5/16; C01B 31/24

(52) U.S. Cl. 428/402; 423/420.2; 977/810

(57) ABSTRACT

The present invention relates to a process for the preparation of nanocrystalline hydrotalcite compounds comprising the steps: introduction of one or more starting compounds into a reaction chamber by means of a carrier fluid, subjecting the starting compound(s) in a treatment zone to a pulsating thermal treatment at a temperature of 250 to 400° C., formation of nanocrystalline metal-oxide particles, discharging of the nanocrystalline hydrotalcite particles from the reactor, wherein the starting compound(s) are introduced into the reaction chamber in the form of a solution, slurry, suspension or in solid aggregate state, and a nanocrystalline hydrotalcite material obtainable by the process according to the invention and its use as an adsorption and catalyst material.

The present invention relates to a process for the preparation of nanocrystalline hydrotalcite compounds and nanocrystalline hydrotalcite compounds obtainable by the process according to the invention and their use.

Hydrotalcites are a class of inorganic materials covered by the term “layered minerals”.

The general formula of hydrotalcite compounds is usually reproduced as M^{II}₁₋ₓM^{III}ₓ(OH)₂Aⁿ⁻_{x/n}yH₂O, wherein M are divalent or trivalent metal cations and Aⁿ⁻ is a n-valent anion.

The mineral hydrotalcite, which both occurs naturally and is prepared synthetically, has the chemical formula Mg₆Al₂(CO₃)OH₁₆.4H₂O. It possesses the ability to bind acids by gradual release of aluminium hydroxide and therefore is widely used in industry and as a medicinal product. The international non-proprietary name (INN) is also hydrotalcite. Hydrotalcite is practically insoluble in water, it must be stored protected from the light and air-tight.

Furthermore hydrotalcites, in particular synthetic hydrotalcites, are used as co-stabilizers for PVC and polyolefins. However, the term hydrotalcite also describes the mineral group of hydrotalcites, which are natural and synthetic variants of the basic double salt hydrotalcite. The English term for this mineral group is “layered double hydroxides (LDH)”. Unlike siliceous clay minerals, hydrotalcite compounds do not contain any silicic acid, SiO₂.

Hydrotalcite compounds include the naturally occurring compounds pyroaurite and sjögrenite as well as manasseite and stichtite, which sometimes differ from one another only by virtue of different stacking sequences of the octahedron layers and which have either a hexagonal or a rhombohedral crystal lattice.

The natural representatives of the hydrotalcite family display exclusively CO₃²⁻ anions and OH-groups as interlayer anions (R. Allmann “Neues Jahrbuch für Mineralogie Monatshefte”, 1968, 140-144). There are also hydrotalcites with a mixed M⁺⁺⁺ position such as nickel/aluminium/chromium or nickel/aluminium/iron hydrotalcites (F. Kooli, Journal of Solid State Chemistry, 118, 1995, 285-291). The synthetic hydrotalcites have either the same formulae as the above-mentioned natural hydrotalcites or make possible access via synthetic methods to combined hydrotalcites such as for example calcium/aluminium sulphate hydrotalcites, magnesium/zinc/hydrotalcite with sulphate anions (F. Kooli et al, Journal of Materials Science 28, 1993, 2769-2773).

Further, in addition to their use as an antacid (cf. N. Bejoy, Resonance 2001, pp 57-61) hydrotalcites are also used as catalysts or also for binding organic solvents or heavy-metal-containing waste. Hydrotalcite compounds generally decompose at temperatures of 300-500° C., forming mixed oxides of the respective di- and trivalent metals.

The preparation of hydrotalcites is adequately known and in the case of the hydrotalcite itself this takes place hydrothermally and also by a wet-chemical process by the precipitation of magnesium carbonate with sodium aluminate followed by calcination.

The thus-obtained hydrotalcites usually have BET surface areas of 30-40 m²/g.

When used as a catalyst the process of calcining the catalyst starting materials during the preparation processes substantially influences the quality of the final catalysts. The same applies when using it as adsorbents, as with these in particular a high BET surface area is advantageous.

The targeted control of the crystallization process can be influenced by the composition of the educt(s), wherein an important factor here is the crystallite size (R. Schlögl et al., “Angewandte Chemie”, 116, 1628-1637 (2004)).

Recently, so-called nanocrystalline powders have increasingly been studied, despite the often unsolved preparation problems. Nanocrystalline oxide powders have thus far usually been prepared either by chemical synthesis, by mechanical processes or by so-called thermophysical processes. In the case of perovskites, for example BET surface areas of 2-10 m²/g are obtained with customary processes and as already stated above, in the case of hydrotalcites, BET surface areas of 30-40 m²/g.

Typically, during chemical wet synthesis, starting from so-called precursor compounds a powder is obtained by chemical reactions, wherein the final structure is typically obtained only after calcination.

Disadvantages are, in addition to the small BET surface areas, often also the irregular size-distribution of the obtained particles, which occurs in particular with the mechanical preparation processes.

Thermophysical methods, such as are described for example in WO 2004/005184, are based on the introduction of thermal energy into solid, liquid or gaseous starting compounds. The previously mentioned international patent application relates in particular to the so-called plasma-pyrolytic spray process (PSP), in which the starting materials are atomized and broken down in an oxyhydrogen flame. A typical technical application is found in the preparation of silicon dioxide, in which volatile silicon compounds are atomized in an oxyhydrogen flame.

It has also been attempted to prepare nanocrystalline particles using so-called plasma synthesis processes, in which the starting materials are evaporated in a plasma heated to 6,000 K. Further customary processes are for example CVD processes, in which gaseous educts are reacted, wherein typically non-oxidic powders form.

An enlargement of the BET surface area of nanocrystalline particles has not been possible using the methods known thus far, in particular due to the then necessary calcinations. Ceramic methods lead to a sintering of the material and thus to a further reduction of the active surface. To increase the activity of the material, both in its function as an adsorbent but also as a possible catalyst, it is however necessary for the porosity, i.e. the surface of the individual particles of the material to also be enlarged.

The preparation methods used thus far only delivered, for hydrotalcite compounds, values for the BET surface area of the hydrotalcite particles below 40 m²/g.

Moreover, with the previous thermal processes there was always the danger of the decomposition of the hydrotalcites even at synthesis temperatures below 400° C., caused in particular by long reaction times.

Therefore, the object of the present invention was to provide a process which avoids the above-named disadvantage of the state of the art and in particular makes it possible to obtain hydrotalcite compounds with BET surface areas of the hydrotalcite particles of more than 40 m²/g. The process is also to be able to be carried out even at low temperatures in order to avoid the decomposition of the hydrotalcites to the mixed oxides of the di- and trivalent metal compounds of the respective hydrotalcite compounds.

This object is achieved according to the invention by a process for the preparation of nanocrystalline hydrotalcite compounds which comprises the following steps:
a) the introduction of one or more starting compounds into a reaction chamber by means of a carrier fluid,
b) the subjecting of the starting compound(s) in a treatment zone to a pulsating thermal treatment using a Helmholtz resonator at a temperature of 250-400° C.,
c) the formation of nanocrystalline hydrotalcite particles,
d) the discharging of the nanocrystalline hydrotalcite particles obtained in steps b) and c) from the reactor, wherein the starting compound(s) are introduced into the reaction chamber in the form of a solution, slurry, suspension or in solid aggregate state.

The process makes possible a precise control of the crystallization process, here in particular the setting of the size of the crystallites and the pore-size distribution of the obtained hydrotalcites.

This can also be additionally advantageously influenced by the residence time in the flame or by the reactor temperature.

Preferred values for the residence time lie between 20 min and 1 h for the reaction temperature at 250-400° C.

Surprisingly the nanocrystalline particles that form are prevented by the pulsating thermal treatment from agglomerating, with the result that discrete nanocrystalline hydrotalcite particles form. Due to the extremely short residence time in the reaction chamber, temperatures of 300-400° can also be briefly set without a thermally-induced decomposition reaction occurring.

Reactors for flameless combustion are known from the state of the art. Thus DD 245674 and DD 245649 disclose a process for the preparation of siliceous materials or single-phase oxides, in which silica sols or metal compounds are atomized in a pulsating combustion in an oscillating-flame reactor and thermally treated. This process produces highly dispersed silica gels or oxides with targeted particle sizes, surface sizes and surface structures.

The working principle of a pulsation reactor, such as is also described in WO-A-02/072471, is the same as that of an acoustic cavity resonator, which comprises a combustion chamber, a resonance tube and a filter for powder separation. The resonance tube is attached exhaust side next to the combustion chamber and has a flow cross-section which is clearly reduced compared with the combustion chamber. The combustion gas mixture entering the combustion chamber is ignited, burns very quickly and creates a pressure wave in the direction of the resonance tube, as the gas-entry side is largely sealed by aerodynamic valves in the case of above-atmospheric pressure. The gas flowing out into the resonance tube creates a below-atmospheric pressure in the combustion chamber, with the result that a new gas mixture flows through the valves and itself ignites. This process of valve closing and opening by pressure and below-atmospheric pressure is self-regulatory and periodic.

In the process according to the invention the flameless combustion process is preferably carried out by the combustion triggering a pressure wave in the resonance tube in the combustion chamber, and initiating an acoustic oscillation. A so-called Helmholtz resonator with pulsating flow thus forms. Such pulsating flows are characterized by a high degree of turbulence. The pulse frequency can be set via the reactor geometry and varied in targeted manner via the temperature. The gas flow resulting from the flameless combustion preferably pulses at 20 to 150 Hz, particularly preferably at 30 to 70 Hz.

Regarding the pressure in the combustion chamber and the speed in the resonance tube unsteady conditions obtain which make possible a particularly intensive heat transfer, i.e. a very rapid and extensive energy transfer of pulsating hot gas flow to the solids particles. Thereby, according to the invention, a very great reaction advance can be achieved with very short residence times in the reactor in the millisecond range, preferably between 1 ms to 2 ms, particularly preferably between 1 ms and 200 ms. In a further preferred process the residence time of the reaction mixture is controlled over a wide range by swirling the starting compounds during or after the reaction. During the formation of the lithium-iron phosphate particles, the reaction mixture is subjected to the influence of a fluidized bed. The reaction mixture thus describes a rotary movement.

Very high peak values of the temperature are reached by periodically recurring thermal pulses in the pulsation reactor. The action of high temperatures on the starting compounds is however of very short duration. A time-averaged low temperature prevails in the reaction zone of the reactor. Advantageously, the reaction is carried out at an average temperature between 100° C. and 400° C., preferably between 250° C. and 450° C., even more preferably between 300° C. and 400° C., most preferably around 300° C. The average temperature is the temperature which can be measured macroscopically. Here, the process according to the invention has a decisive advantage over the processes from the state of the art. In known processes, the above-mentioned reactions take place at 600° C. or more.

Due to the reaction taking place at low temperatures, a particularly fine particle geometry is obtained. The temperature at which the reaction takes place also influences the surface of the thus-obtained hydrotalcite particles.

Typically the nanocrystalline hydrotalcite particles are immediately conveyed by the stream of hot gas into a colder zone, where they are obtained as nanocrystallites sometimes with a diameter of less than 20 nm.

The hydrotalcites obtained by means of the process according to the invention have clearly increased BET surface areas of 50-200 m²/g, preferably 70-150 m²/g.

By using the process according to the invention a reduction of more than 20% in reaction time when preparing hydrotalcite particles can also be achieved. Previously, the synthesis of hydrotalcites by means of the standard processes lasted approx. 1-2 days, but with the process according to the invention the synthesis is finished after approx. 1 h.

The quantities of the hydrotalcites obtained by means of the process according to the invention that are conveyed are between 300 g to 1 t per day.

Further advantages of the process according to the invention are that for example, without additional filtration and/or drying steps or without the addition of additional solvents suspensions can usually be calcined within a very short period, typically within a few milliseconds at comparatively lower temperatures than with the previously known process from the state of the art, and thus the decomposition reaction of the hydrotalcite compounds can be completely eliminated.

The nanocrystalline hydrotalcite compounds that form have, as explained above, significantly increased BET surface areas, which in the case of use as catalysts leads to catalysts with increased reactivity, improved conversion and selectivity.

Due to the nearly identical residence time of every particle in the homogeneous temperature field created by the process there is also an extremely homogeneous end-product with a narrow monomodal particle distribution.

A device for carrying out the process according to the invention for the preparation of such monomodal nanocrystalline hydrotalcites is for example known from DE 101 09 82 A1.

Unlike the device described there and the process disclosed there, the present process does not, however, require a front-end evaporation step in which starting materials must be heated to an evaporation temperature.

Typically, the materials from which the hydrotalcite compounds according to the invention are prepared are directly introduced via a carrier fluid, in particular a carrier gas, preferably an inert carrier gas, such as for example nitrogen, etc., into the so-called reaction chamber, more accurately into the combustion chamber. Attached exhaust side to the reaction chamber is a resonance tube with a flow cross-section which is clearly reducing compared with the reaction chamber. The floor of the combustion chamber is equipped with several valves for the entry of the combustion into the combustion chamber. The aerodynamic valves are matched in terms of flow engineering and acoustics to the combustion chamber and the resonance-tube geometry such that the pressure waves, created in the combustion chamber, of the homogeneous flameless temperature field spread pulsating predominantly in the resonance tube. A so-called Helmholtz resonator with pulsating flow thus forms.

Material is typically supplied to the reaction chamber either with an injector or with a suitable two-component jet or by a Schenk dispenser. Preferably, the starting compound is introduced into the reaction chamber in dissolved form, with the result that a fine dispersion in the area of the treatment zone is guaranteed. The solutions can be sprayed very finely dispersed into the reaction space. The compounds are preferably introduced into the reactor by spraying the dissolved compounds in with a carrier fluid with a pressure of 15 to 40 bar. A very rapid drainage and a rapid conversion of the starting compounds thereby take place, with the result that the desired product can be obtained in finely crystalline form. An advantage of the use of aqueous solutions is also the environmental friendliness of the medium. The water can be condensed after the reaction and need not be expensively treated and disposed of. Also, organic auxiliaries and solvent components can be added to the solutions.

The process according to the invention thus makes possible the preparation of monomodal, nanocrystalline hydrotalcite compounds by direct introduction. Surprisingly, already pre-precipitated hydrotalcite compounds can also be introduced directly into the combustion chamber without the crystalline materials that form needing to be filtered. Furthermore, the process according to the invention makes possible a lower temperature when preparing the hydrotalcite compounds according to the invention. Moreover, when using solutions from metal salts, an additional precipitation step can be avoided, with the result that these can be calcined directly in the reactor. Calcination takes place, as already stated above, at lower temperatures than known from the state of the art, with the result that the decomposition reaction of the hydrotalcites can be completely eliminated.

The carrier fluid is preferably a gas, such as for example air, nitrogen or air/nitrogen mixtures. It serves to introduce the starting compounds into the reactor in a fine and uniform distribution. With the help of the carrier a turbulent flow is also produced which is very important for producing fine nanocrystal particles with a very narrow size distribution.

Quite particularly preferably the carrier fluid is a gas which contains a combustible gas. The reactor can thereby be supplied with a combustible gas by means of which the reactor can be brought to the desired temperature.

The particles produced in the reactor are removed from the reactor area with a suitable separation device. As the particles can be very fine, nanocrystalline particles, in a preferred embodiment these are removed from the product gas stream, for example by a gas cyclone, a surface or an electrical precipitator. A liquid, or even starting materials present already in solution, can naturally also be alternatively used as fluid. The nature of the carrier fluid has influence in particular on the residence time in the treatment zone. Thus for example, suspensions and slurries of poorly soluble compounds such as sulphates, oxides, nitrides, etc., can also be used directly according to the invention.

It is advantageous if different starting compounds are used, which in particular are different from one another, in order to also prepare more complex hydrotalcites or mixed hydrotalcites or even doped hydrotalcites. This is advantageous in particular if for example more complex catalyst systems which are based on the synergy of different metals in hydrotalcite are to be prepared.

By controlling the pulsation (regularly or irregularly or the duration and amplitudes of the pulsating thermal treatment) and the residence time of the starting compound(s) in the treatment zone (typically of 200 ms-2 s), the crystallite size can also be decisively influenced.

In addition to the thermal treatment, the nanocrystalline hydrotalcites that form are, if possible, immediately transferred into a colder zone of the reaction chamber by means of the carrier fluid, with the result that they are separated in the colder zone and can be discharged. The yield of the process according to the invention is almost 100%, as all of the product that forms can be discharged from the reactor as a solid.

As already stated above, it was surprisingly found that hydrotalcites already present in solid form can also be used as starting materials which according to the invention are converted by the subsequent pulsating temperature treatment into nanocrystalline particles with a high BET surface area, which leads to the position of a calcining treatment of the processes of the state of the art and thus also prevents a decomposition of the hydrotalcites.

This advantageously opens up another application field of the process according to the invention, as it is not necessary to select specific starting compounds, for example with regard to their solubility, evaporation, etc., but that e.g. the hydrotalcite can be prepared firstly by customary processes, wet-chemical for example, and then only the calcining of the finished product in the so-called pulsation reactor takes place.

Naturally, it is equally possible that in further preferred developments of the process according to the invention soluble metal compounds are used as starting compound. In particular carbonates, hydroxides, nitrates and sulphates of metals or transition metals are used.

These are in particular carbonates, nitrates, hydroxides and sulphates of magnesium, zinc, calcium, aluminium, nickel, manganese and iron, with the result that more complex hydrotalcites, such as have already been mentioned above, can also be prepared.

As examples of hydrotalcites already obtained by wet-chemical processes, there may be mentioned here the classic hydrotalcite (Mg₆Al₂OH₁₆CO₃.nH₂O), manasseite (Mg₃Fe(OH)₈CO₃.nH₂O), pyroaurite or sjögrenite (Mg₃Cr(OH)₈CO₃.nH₂O), stichtite or barbertonite (Mg₃Mn(OH)₈CO₃.nH₂O), desautelsite (Mg₃Fe(OH)₉.2H₂O), meixnerite (Ni₃Al(OH)₉CO₃.4H₂O) and takovite.

Further hydrotalcites obtainable according to the invention are also mentioned for example in the publication by W. Hofmeister and H. von Platen, “Crystal Chemistry and Atomic Order in Brucite related doublelayer Structures”, Crystallography Reviews, 3, 1992, pp. 3-29, reference to the complete disclosure content of which is made here. All these hydrotalcites obtainable by wet-chemical processes can be calcined by means of the process according to the invention and then display a high porosity and monomodal particle distribution of the obtained nanocrystallites.

In further preferred embodiments doped hydrotalcites can also be prepared, wherein additional solutions of starting compounds, for example made from soluble cerium, iron, copper, nickel, silver and gold compounds can also be added. Here in particular their nitrates, chlorides, acetates, etc., are then also preferred, as these are more easily soluble.

It was further surprisingly found that the thermal treatment according to the process according to the invention can be carried out at temperatures of 250-450° C., which is advantageous vis-à-vis the thermal decomposition processes known thus far or the calcination processes, which are carried out at higher temperatures, as the above-stated decomposition or secondary reactions can be eliminated, with the result that the product of the process according to the invention contains almost no impurities and the energy balance is also more favourable when carrying out the process according to the invention, as the energy consumption is lower. Typically, the process is carried out at a pressure between 15-40 bar.

The object of the present invention is also achieved by a nanocrystalline hydrotalcite material which can be obtained by the process according to the invention. It was found that the nanocrystalline hydrotalcite material according to the invention preferably has a crystallite size in the range from 5 nm-100 μm, preferably from 10 nm-10 μm, with a monomodal distribution which, as already stated above, can be set by the pulsation of the thermal treatment.

The hydrotalcite material obtainable according to the invention also has a BET surface area of more than 40 m²/g, particularly preferably of more than 100 m²/g, typically in the range of 50-120 m²/g. In individual cases BET surface areas of up to 150 m²/g are even achieved.

The process according to the invention is described in more detail with reference to the following embodiment examples, which are not to be regarded as limitative. The device used corresponds largely to the device described in DE 101 09 82 A1, with the difference that the device used for carrying out the process according to the invention had no preliminary evaporator step.

### EXAMPLE 1

Firstly, a hydrotalcite raw material was prepared according to a wet-chemical process known per se by converting magnesium carbonate in an alkaline solution of 50% KOH by adding AlOH₃ into hydrotalcite and precipitating it out by cooling it to 70° C.

The spray drying of the thus-obtained material takes place in the device according to the invention. The obtained filter cake was slurried with 37 l water, resulting in 59.6 kg crude suspension, which was atomized respectively in four part quantities each of 15 kg. The charge in the pulsation reactor was approx. 12.5 kg per hour.

The temperature of the pulsation reactor was 250-400° C. and therefore lies below that of the spray dryer, which operates at 450-500° C., whereby the possible secondary reactions during the temperature-induced decomposition of hydrotalcites into di- and trivalent metal oxides of the hydrotalcite can be avoided.

The BET surface area of the thus-obtained material was typically more than 100 m²/g.

The tests are reproduced in the following table:

### Evaluation:

| | | Quantity of | | BET surface |
|---|---|---|---|---|
| | Temp. | product | Evaluation | area |
| Sample | [° C.] | [kg] | XRD | [m²/g] |
| 1 | 500 | 0.27 | no hydrotalcite | 95 |
| 2 | 400 | 0.41 | hydrotalcite | 105 |
| 3 | 300 | 0.75 | hydrotalcite | 81 |
| 4 | 250 | 0.50 | hydrotalcite | 102 |

It transpires that hydrotalcite could be obtained at temperatures of 250-400° C. with BET surface areas of 81-105 m²/g by means of the process according to the invention, while at temperatures above 400° C. not hydrotalcite, but thermally-induced decomposition products, were obtained. The best values for the BET surface areas were obtained between 300-400° C.

### EXAMPLE 2

Example 2 shows the preparation of hydrotalcite materials according to the invention directly in the pulsation reactor.

MgCO₃ was dissolved in water and heated to 90° C. and stirred. (Solution 1)

Further, a 50% KOH solution to which a AlOH₃ solution was added was heated to 75° C. (Solution 2).

The suspension heats up on its own or by slight heating to 105° C., wherein a milky solution resulted.

Both solutions were introduced separately atomized at 350° C. into the pulsation reactor via a nozzle in order to avoid decomposition reactions of the resulting hydrotalcite.

The obtained product was pure hydrotalcite and had a BET surface area of 120 m²/g.

It was shown that, compared with the introduction of the already pre-synthesized crude talcite, the direct synthesis of hydrotalcite in the reactor from the starting compounds produces in higher BET surface areas.

1. Process for the preparation of nanocrystalline hydrotalcite compounds comprising the steps
a) introduction of one or more starting compounds into a reaction chamber by means of a carrier fluid,
b) subjecting the starting compound(s) in a treatment zone to a pulsating thermal treatment using a Helmholtz resonator at a temperature of 250 to 400° C.,
c) formation of nanocrystalline metal-oxide particles,
d) discharging of the nanocrystalline hydrotalcite particles obtained in steps b) and c) from the reactor,
characterized in that the starting compound(s) are introduced into the reaction chamber in the form of a solution, slurry, suspension or in solid aggregate state.

2. Process according to claim 1, characterized in that the carrier fluid is a gas.

3. Process according to claim 1, characterized in that the starting compound(s) is (are) introduced into the reaction chamber in atomized form.

4. Process according to claim 1, characterized in that several starting compounds, different from one another, are used.

5. Process according to claim 1, characterized in that the pulsation of the pulsating thermal treatment takes place regularly or irregularly.

6. Process according to claim 1, characterized in that, after the thermal treatment in the treatment zone, the nanocrystalline hydrotalcite particles that form are transferred into a colder zone of the reaction chamber.

7. Process according to claim 1, characterized in that hydroxides, carbonates or sulphates or their mixtures of Mg, Zn, Ca, Al, Ni, Mn and Fe are used as starting compound.

8. Process according to claim 1, characterized in that Mg₃Fe(OH)₈CO₃.nH₂O, Mg₃Fe(OH)₉.2H₂O, Mg₃Cr(OH)₈CO₃.nH₂O, Ni₃Al(OH)₉CO₃.4H₂O, Mg₃Mn(OH)₈CO₃.nH₂O are used as starting compound.

9. Process according to claim 1, characterized in that further starting compounds are added, selected from the group consisting of Ce, Fe, Cu, Ni Ag and Au compounds.

10. Process according to claim 1, characterized in that soluble metal compound(s) are used as starting compound(s).

11. Process according to claim 1, characterized in that the process is carried out at a pressure between 15-40 bar.

12. Nanocrystalline hydrotalcite made by the process of claim 1.

13. Nanocrystalline hydrotalcite material made by the process of claim 1, characterized in that its crystallite size lies in the range from 10 nanometres to 10 micrometres.

14. Nanocrystalline hydrotalcite material made by the process of claim 1, characterized in that it has a BET surface area of >40 m²/g.
